(19) United States
(12) Patent Application Publication
(10) Pub. No.: US 2025/0094548 A1
(43) Pub. Date: Mar. 20, 2025

(54) ASSEMBLY CONTROL WITH AUTHENTICATION OF USER

(71) Applicant: RTX CORPORATION, Farmington, CT (US)

(72) Inventors: Paul A. Adamski, Westfield, MA (US); Anteneh B. Abrham, East Granby, CT (US); Alison K. Adamski, Westfield, MA (US); Jason Dejesus, Norwalk, CT (US)

(21) Appl. No.: 18/468,365

(22) Filed: Sep. 15, 2023

(51) Int. Cl. G06F 21/31; G06F 21/62

(52) U.S. Cl. CPC G06F 21/31; G06F 21/6218; G06F 2221/2113

(57) ABSTRACT

An embedded processing system and access combination includes processing circuitry, a memory system, and a plurality of user credential files. The user credential files include an encrypted user identifier, and an encrypted list of authorized task roles the particular user would have within the embedded processing system. Expected credentials from the user credential files are stored in the memory system. The processing system is programmed to receive a user credential file from a user, and compare expected credentials within the memory system to identify if the user is an authorized user. The processing system is programmed to allow access to an authorized user and deny access to an unauthorized user and determine what task roles are authorized for the authorized user, and deny access for the authorized user to other tasks. A method and an assembly are also disclosed.

### BACKGROUND OF THE INVENTION

This application relates to a control for an assembly that allows limited access to user, and wherein there is an authentication process.

Modern assemblies are being provided with more and more complex controls. One example is an aircraft having gas turbine engines. A main control for the gas turbine engine is known as a full authority digital electronic controller (“FADEC”).

In existing controllers, users, authorized or not, often have undesirably broad access.

### SUMMARY OF THE INVENTION

In a featured embodiment, an embedded processing system and access combination includes processing circuitry, a memory system, and a plurality of user credential files. The user credential files include an encrypted user identifier, and an encrypted list of authorized task roles the particular user would have within the embedded processing system. Expected credentials from the user credential files are stored in the memory system. The processing system is programmed to receive a user credential file from a user, and compare expected credentials within the memory system to identify if the user is an authorized user. The processing system is programmed to allow access to an authorized user and deny access to an unauthorized user and determine what task roles are authorized for the authorized user, and deny access for the authorized user to other tasks.

In another embodiment according to the previous embodiment, the user credential file is digitally signed.

In another embodiment according to any of the previous embodiments, if the received user credential file is not validated, then a failure is logged and stored in a log memory including the identity of the unauthorized user.

In another embodiment according to any of the previous embodiments, if the user attempts to perform a task that is not authorized, access is denied, and the incident is logged and stored in a log memory.

In another embodiment according to any of the previous embodiments, one level of access is a security access to the log memory.

In another embodiment according to any of the previous embodiments, one level of access is the ability to re-program the embedded processing system.

In another embodiment according to any of the previous embodiments, one level of access is at least one of maintenance, repair or overhaul.

In another embodiment according to any of the previous embodiments, one level of access is at least one type of testing.

In another featured embodiment, a method of operating an embedded processing system includes providing a plurality of user credential files that include an identifier for each of a plurality of users, and tasks that are authorized for each of the plurality users, and encrypting the credential files. Expected valid user information and access information is stored at a memory within the embedded processing system. One of the user credential files is stored at the embedded processing system, and checking the received user credential file against the stored expected valid user information and access information. Access is denied should the received user credential file not be validated from the expected user information. The user is allowed access if the received user credential file matches the expected valid user information. An access control list of authorized task roles is set by accessing the access information in the memory. Allowing access for the user to the authorized task roles during a session and denying access for any other task roles.

In another embodiment according to any of the previous embodiments, the credential file is digitally signed.

In another embodiment according to any of the previous embodiments, if the received user credential file is not validated, then the failure is logged, and stored in a log memory, including the user's identity.

In another embodiment according to any of the previous embodiments, if the user attempts to perform a task role that is not authorized, access is denied, and the incident is logged and stored in the log memory.

In another embodiment according to any of the previous embodiments, one level of authorized access is a security access to the log memory.

In another embodiment according to any of the previous embodiments, one level of authorized access is the ability to re-program the embedded processing system.

In another embodiment according to any of the previous embodiments, one level of access is one of maintenance, repair or overhaul.

In another embodiment according to any of the previous embodiments, one level of access is at least one type of testing.

In another embodiment according to any of the previous embodiments, a session is ended after a period of time without activity, or when the user requests an exit.

In another featured embodiment, an assembly includes a mechanical system and an embedded processing system for the mechanical system. The embedded processing system includes an embedded processing system and access combination including processing circuitry, a memory system, and a plurality of user credential files. The user credential files include an encrypted user identifier, and an encrypted list of authorized task roles the particular user would have within the embedded processing system. Expected credentials from the user credential files are stored in the memory system. The processing system is programmed to receive a user credential file from a user, and compare expected credentials within the memory system to identify if the user is an authorized user. The processing system is programmed to allow access to an authorized user and deny access to an unauthorized user and determine what task roles are authorized for the authorized user, and deny access for the authorized user to other tasks.

In another embodiment according to any of the previous embodiments, the credential file is digitally signed.

In another embodiment according to any of the previous embodiments, the assembly is a gas turbine engine.

The present disclosure may include any one or more of the individual features disclosed above and/or below alone or in any combination thereof.

These and other features of the present invention can be best understood from the following specification and drawings, the following of which is a brief description.

### BRIEF DESCRIPTION OF THE DRAWINGS

FIG. 1A schematically shows a gas turbine engine on an aircraft.

FIG. 1B is a block diagram of a control system.

FIG. 2 schematically shows a landscape of a user access system.

FIG. 3 schematically shows a user's credential file.

FIG. 4 is a flow chart of credential file validation.

FIG. 5 is a flow chart of role definition.

FIG. 6 is a flow chart of command processing.

### DETAILED DESCRIPTION

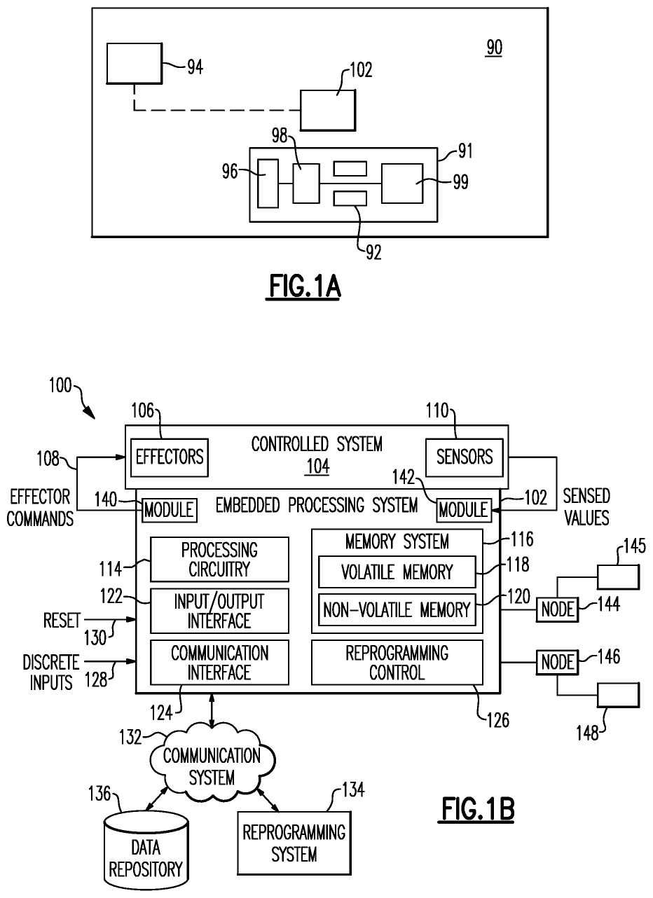

FIG. 1A schematically shows an assembly 90. In a disclosed embodiment assembly 90 may be an aircraft. A gas turbine engine 91 is shown as associated with the aircraft 90. In some embodiments gas turbine engine 91 could be seen as an assembly for purposes of this disclosure. Gas turbine engine 91 has a fan 96, a compressor section 98, a combustor section 97 and a turbine section 99. It should be understood that this is a highly schematic description. While a gas turbine engine and aircraft are disclosed as the assemblies and the associated control, other assemblies and controls may benefit from this disclosure.

As shown, an embedded processing system 102 communicates with a control 94 on the aircraft 90. The embedded processing system 102 may be a full authority digital electronic controller or FADEC for engine 91.

FIG. 1B shows details of a system 100 including the embedded processing system 102 and a controlled system 104. Here, the controlled system 104 may include systems on the gas turbine engine of FIG. 1A.

The FIG. 1B system includes the embedded processing system 102 and a controlled system. The controlled system 104 can be any type of physical system that includes one or more effectors 106 controlled by one or more effector commands 108. The effector commands 108 are received from a module 140 associated with the embedded processing system 100.

Examples of effectors can include one or more motors, solenoids, valves, relays, pumps, heaters and/or other such actuation control components.

As also shown, systems 145 and 148 may have control nodes 144 and 146 that communicate to the embedded processing system 102. As an example, the system 145 may be an anti-ice system.

A plurality of sensors 110 can capture state data associated with the controlled system 104 and provide sensed values 112 as feedback to a module 142 in the embedded processing system 102 to enable closed-loop control of the controlled system 104 according to one or more control laws.

Examples of the sensors can include one or more temperature sensors, pressure sensors, strain gauges, level sensors, accelerometers, rate sensors, and the like.

While modules 140 and 142 are shown as part of the embedded processing system 102, nodes 144 and 146 are outside but communicating with embedded processing system 102.

While the controlled assembly is disclosed as a gas turbine engine, it can be other types of engines, a vehicle, a heating ventilating and air conditioning (“HVAC”) system, an elevator system, industrial machinery, or the like.

For purposes of explanation, embodiments are primarily described with respect to a gas turbine engine system for an aircraft 90 as the controlled system and assembly, and in particular, the gas turbine engine 91.

In the FIG. 1B example, the embedded processing system 102 includes processing circuitry 114 and a memory system 116 configured to store a plurality of configuration items, where at least one of the configuration items includes a sequence of computer executable instructions for execution by the processing circuitry 114. Types of configuration items can include data, such as constants, configurable data, and/or fault data. Examples of computer executable instructions can include software, operating system software, and/or application software. The executable instructions can be stored or organized in any manner and at any level of abstraction, such as in connection with controlling and/or monitoring operation of the controlled system 104. The processing circuitry can be any type or combination of central processing unit (“CPU”), including one or more of: a microprocessor, a digital signal processor, a microcontroller, an application specific integrated circuit, a field programmable gate array, or the like.

In embodiments, the memory system may include volatile memory 118 such as random access memory, and non-volatile memory 120, such as flash memory, read only memory, and/or other electronic, optical, magnetic, or any other computer readable medium onto which is stored data and algorithms in a non-transitory form.

The embedded processing system 102 can also include one or more of an input/output interface 122, a communication interface 124, a reprogramming control 126, and/or other elements.

The input/output interface 122 can include support circuitry for interfacing with the effectors 106 and sensors 110, such as filters, amplifiers, digital-to-analog converters, analog-to-digital converters, and other such circuits to support digital and/or analog interfaces. Further, the input/output interface 122 can receive or output signals to/from other sources. As one example, discrete inputs 128 can be input to the input/output interface to establish an operating mode of the embedded processing system 102, or to trigger actions by the embedded processing system 102.

A reset signal 130 may also be internally introduced as a result of power detected by power conditioning circuitry, and by specific hardware or software direction. The communication interface 124 can be coupled to a communication system 132, which can include one or more direct or network communication links to systems such as a reprogramming system 134, a data repository 136, or another system. The communication system 132 may also communicate with the control 94 on the associated aircraft 90.

The reprogramming system 134 can be any type of computer system operable to load new/updated configuration items to the embedded processing system 102 for storage in the memory system 116. The reprogramming system 134 can interface to the communication system 132 to a wired, wireless, optical, or magnetic coupling. The data repository 136 can serve as a data source for updating the memory system 116, for instance, with control system data, or as a data sync to offload and clear data from the memory systems, such as fault data, history data, and the like.

Access to an embedded processing system such as that disclosed above is required for many purposes such as diagnostics testing, reprogramming, data collection, etc. In the past users may have gained access to such a system without appropriate limits on access to unauthorized users. Moreover, it is often true that an authorized user for one purpose has access beyond that one purpose.

It has been proposed in the past to have access limited to such a processing system based upon a user's defined role. However, it is desirable to provide further details of how to best do so.

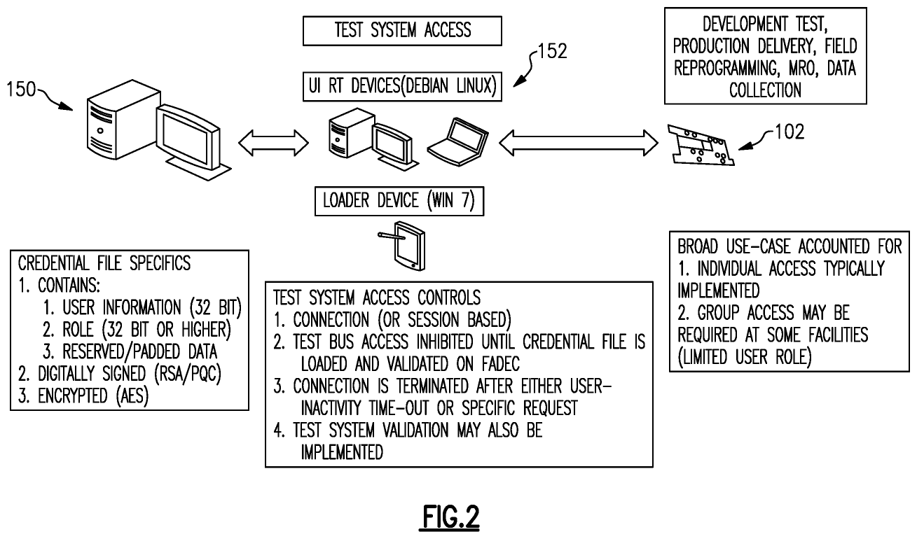

As shown in FIG. 2, a landscape allows the embedded processing system 102 to have the ability to control access across its lifetime. As shown, a credential is created at 150 in a factory environment that will limit users to specific roles. A credential file is prepared for each user. The credential file typically includes user information, and a role for a plurality of users. There may also be reserved or padded data providing space should there come a time when additional information would be desirable.

This credential is digitally signed, for example, by post quantum cryptography (“PQC”) or RSA. Further, the information is all encrypted. Once the embedded processing system 102 is operational, test system access would be determined at 152. A user would supply their credential file. The processing system 102 would have access inhibited until an appropriate credential file is loaded and validated. A connection is terminated after either user inactivity for a period of time, or a specific request. The test system being used may also be provided with validation functions.

This would allow tests to take place on the processing system and the associated assembly over its lifetime.

The processing system 102 is shown schematically. Further development tests, production delivery, fuel delivery, programming, maintenance repair or overall and data collection would also occur across the lifetime of the processing system. Again, individual access will typically be implemented. However, group access may be required at some facilities but still with limited user role.

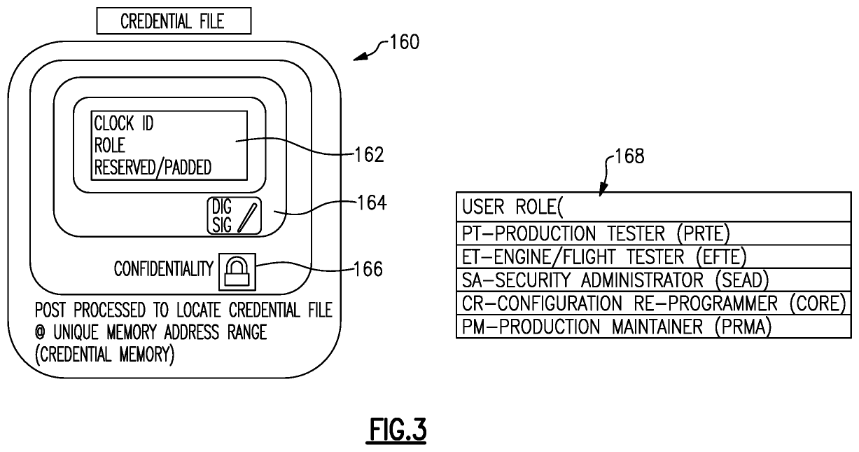

FIG. 3 shows an example of a credential file of a particular user. At 160, a credential file is shown that a user would typically deliver to the embedded processing system to gain access. At 162 there is an embedded clock ID and role as mentioned above. This information is digitally signed at 164 as mentioned above. It is then encrypted at 166. The credential file is delivered in some manner such as a USB plug being plugged in and delivering the information. Other ways of delivering information may also be utilized. As one example, the user may send a file transferred to the embedded processing system.

At 168 typical user roles are listed, to provide examples of the roles that may be appropriate for particular individuals. As can be seen, some individuals may be authorized to test. A security administrator may need access to logs, as explained below. In particular, attempts to gain improper access are logged and an administrator may need access. There may be a re-programmer or a production maintenance individual. This is not an exhaustive list.

As shown in FIG. 3, the credential file is post processed prior to being sent to the FADEC. Essentially a wrapper is placed around the file prior to sending it to the FADEC with load content and a location. The FADEC looks for certain expected information in the wrapper which will tell the FADEC a load location. In this way the FADEC knows where to put the information.

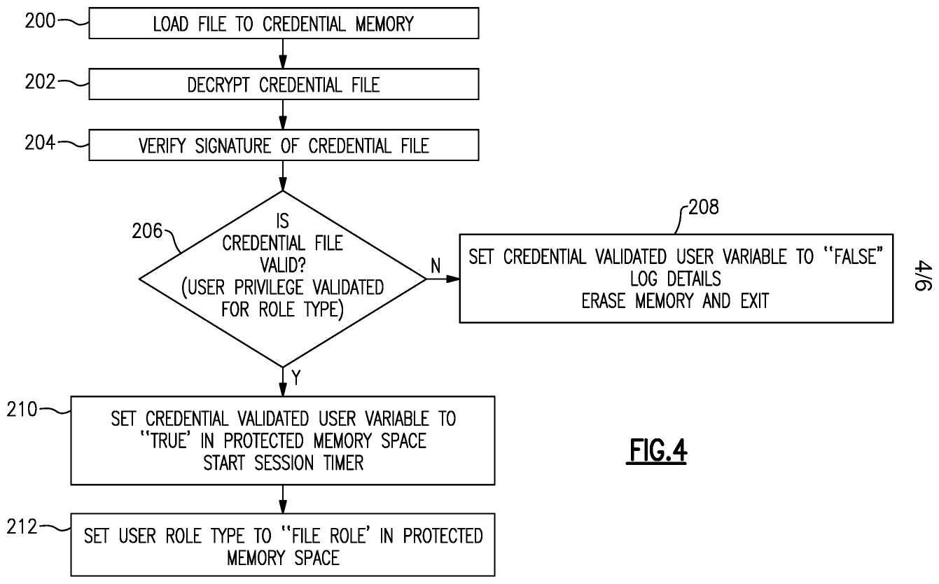

FIG. 4 is a flow chart of how the embedded processing system might validate a credential file. At step 200 the credential file is loaded to a credential memory. At step 202 a received credential file is decrypted. At step 204 the credential file is verified. At step 206 if the credential file is valid, then user privilege is validated based upon the role type. If the credential file is not found valid then at step 208 the processing system sets the credential validated user variable to “FALSE.” Details are logged including the attempted user's identity. The memory is erased and the system exits.

At step 210 if the credential file is found valid at step 206, the credential validated user variable is set to TRUE in a protected memory space, and a section timer is started. At step 212 the user role type is also stored in memory to allow access to certain areas, and deny access in others.

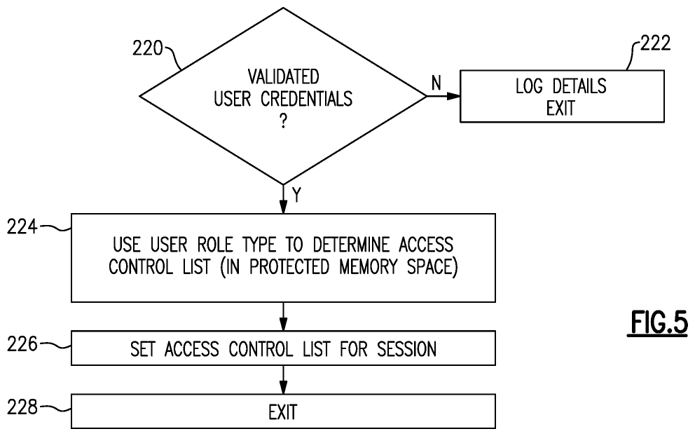

FIG. 5 is a flow chart of defining a role of a particular user. Again, at step 220 the credentials of a user are validated. If they are found invalid at step 222 details are logged and the system exits. However, if the credentials are validated at step 220 then at step 224 a user role type is identified to determine an access control list. At step 226 an access control list is set for the particular session.

A worker of skill in this art would recognize that if the embedded processing system is say a FADEC there would be hundreds of different test protocols as an example. Not all test engineers would have access to all such tests. Thus, the access is typically not as broad as all testing. At step 228 the system exits at the end of the session.

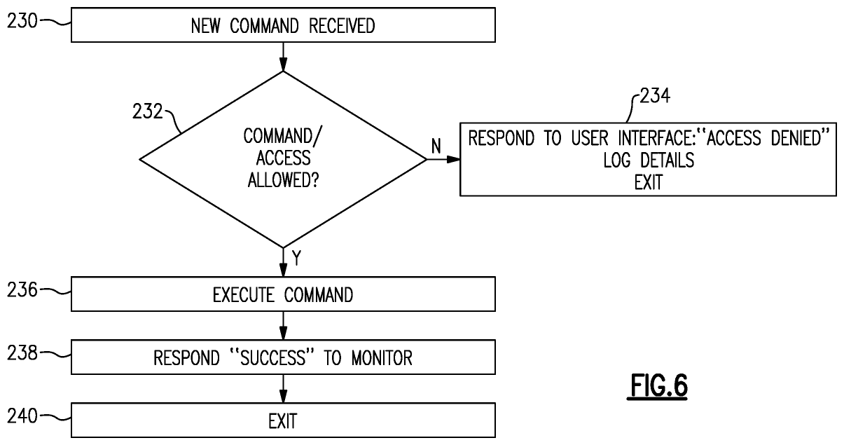

FIG. 6 shows a flow chart for processing a received command. At step 230 a new command is received. At step 232 the system asks if the command received is something that the identified user has authority or access for. If not, at step 234 a user interface is provided with response “ACCESS DENIED.” Details are logged and the system exits. However, if step 232 finds that the access is allowed, then at step 236 a command is executed. At step 238 a response of “SUCCESS” is provided to the user interface. At step 240 the system exits.

An embedded processing system and access combination under this disclosure could be said to include processing circuitry, a memory system, and a plurality of user credential files. The user credential files include an encrypted user identifier, and an encrypted list of authorized task role the particular user would have within the embedded processing system. Expected credentials from the user credential files is stored in the memory system. The processing system is programmed to receive a user credential file from a user, and compare expected credentials within the memory system to identify if the user is an authorized user. The processing system allows access to an authorized user and denies access to an unauthorized user and determines what task roles are authorized for the validated user, and deny access for the authorized user to other task roles.

A method of operating an embedded processing system under this disclosure could be said to include providing a plurality of user credential files that include an identifier for the particular user, and task roles that are authorized for each of the users, and encrypting the user credential files. Expected valid user information and access information is stored at a memory within the embedded processing system. One of the user credential files is received at the embedded processing system, and checking the received user credential file against the stored expected valid user information and access information. Access is denied should the received user credential file not be validated from the expected user information. The user is allowed access if the received user credential file matches the expected valid user information. An access control list is set by accessing the access information in the memory. Allowing access for the authorized user to the authorized tasks during a session and denying access for any unauthorized tasks.

Although embodiments of this disclosure have been shown, a worker of ordinary skill in this art would recognize that several modifications would come within the scope of this disclosure. For that reason, the following claims should be studied to determine the true scope and content of this disclosure.

What is claimed is:

1. An embedded processing system and access combination comprising:
processing circuitry;
a memory system;
a plurality of user credential files, the user credential files including an encrypted user identifier, and an encrypted list of authorized task roles the particular user would have within the embedded processing system
expected credentials from the user credential files are stored in the memory system; and
the processing system being programmed to receive a user credential file from a user, and compare expected credentials within the memory system to identify if the user is an authorized user, the processing system programmed to allow access to an authorized user and deny access to an unauthorized user and determine what task roles are authorized for the authorized user, and deny access for the authorized user to other tasks.

2. The combination as set forth in claim 1, wherein the user credential file is digitally signed.

3. The combination as set forth in claim 1, wherein if the received user credential file is not validated, then a failure is logged and stored in a log memory including the identity of the unauthorized user.

4. The combination as set forth in claim 2, wherein if the user attempts to perform a task that is not authorized, access is denied, and the incident is logged and stored in a log memory.

5. The combination as set forth in claim 4, wherein one level of access is a security access to the log memory.

6. The combination as set forth in claim 1, wherein one level of access is the ability to re-program the embedded processing system.

7. The combination as set forth in claim 1, wherein one level of access is at least one of maintenance, repair or overhaul.

8. The combination as set forth in claim 1, wherein one level of access is at least one type of testing.

9. A method of operating an embedded processing system comprising:
providing a plurality of user credential files that include an identifier for each of a plurality of users, and tasks that are authorized for each of the plurality users, and encrypting the credential files;
storing expected valid user information and access information at a memory within the embedded processing system;
receiving one of the user credential files at the embedded processing system, and checking the received user credential file against the stored expected valid user information and access information;
denying the user access should the received user credential file not be validated from the expected user information;
allowing the user access if the received user credential file matches the expected valid user information;
setting an access control list of authorized task roles by accessing the access information in the memory; and
allowing access for the user to the authorized task roles during a session and denying access for any other task roles.

10. The method as set forth in claim 9, wherein the credential file is digitally signed.

11. The method as set forth in claim 9, wherein if said received user credential file is not validated, then the failure is logged, and stored in a log memory, including the user's identity.

12. The method as set forth in claim 10, wherein if the user attempts to perform a task role that is not authorized, access is denied, and the incident is logged and stored in the log memory.

13. The method as set forth in claim 11, wherein one level of authorized access is a security access to the log memory.

14. The method as set forth in claim 9, wherein one level of authorized access is the ability to re-program the embedded processing system.

15. The method as set forth in claim 9, wherein one level of access is one of maintenance, repair or overhaul.

16. The method as set forth in claim 9, wherein one level of access is at least one type of testing.

17. The method as set forth in claim 9, wherein a session is ended after a period of time without activity, or when the user requests an exit.

18. An assembly comprising a mechanical system and an embedded processing system for the mechanical system, the embedded processing system having:
an embedded processing system and access combination comprising:
processing circuitry;
a memory system;
a plurality of user credential files, the user credential files including an encrypted user identifier, and an encrypted list of authorized task roles the particular user would have within the embedded processing system;
expected credentials from the user credential files are stored in the memory system; and
the processing system being programmed to receive a user credential file from a user, and compare expected credentials within the memory system to identify if the user is an authorized user, the processing system programmed to allow access to an authorized user and deny access to an unauthorized user and determine what task roles are authorized for the authorized user, and deny access for the authorized user to other tasks.

19. The assembly as set forth in claim 18, wherein the credential file is digitally signed.

20. The assembly as set forth in claim 18, wherein the assembly is a gas turbine engine.
